(19) United States
(12) Patent Application Publication
(10) Pub. No.: US 2025/0363818 A1
(43) Pub. Date: Nov. 27, 2025

(54) METHOD, APPARATUS AND NON-TRANSITORY COMPUTER-READABLE STORAGE MEDIUM FOR DETERMINING VIDEO CONTINUITY

(71) Applicant: Nanning FuLian FuGui Precision Industrial Co., Ltd., Nanning (CN)

(72) Inventor: QIAN LU, Shenzhen (CN)

(21) Appl. No.: 19/001,726

(22) Filed: Dec. 26, 2024

(30) Foreign Application Priority Data
May 23, 2024 (CN) 202410649555.2

(51) Int. Cl. G06V 20/00; G06T 7/215; G06T 7/246; G06T 7/90; G06V 20/40

(52) U.S. Cl. CPC G06V 20/95; G06T 7/215; G06T 7/246; G06T 7/90; G06V 20/46; G06T 2207/10016; G06T 2207/10024

(57) ABSTRACT

A method, apparatus and non-transitory computer-readable storage medium for determining video continuity. The method first extracts individual frames from the video and compares adjacent frames to identify dynamic regions within each frame. Subsequently, pixels with similar colors and nearby positions within the dynamic regions are grouped into pixel blocks. By determining whether these pixel blocks represent moving objects and analyzing the color and motion changes of the boundary pixels of the moving objects, the continuity of the entire video can be determined.

### FIELD

A method, apparatus and non-transitory computer readable storage medium for determining video continuity.

### BACKGROUND

Video data continuity refers to the uninterrupted and unedited nature of a recording, accurately reflecting the sequence of events. However, due to the ease with which videos can be tampered with or forged by malicious actors, they often fail to provide a true representation of the events they purport to depict. Particularly in the legal domain, video evidence must be original to be admissible. Therefore, it is imperative to determine whether video data is continuous and authentic.

Currently, the primary method for assessing video continuity is manual inspection. However, manual methods are not only time-consuming but also prone to human error, especially as editing and forgery techniques become increasingly sophisticated. The human eye alone is often insufficient to reliably detect video manipulations.

### BRIEF DESCRIPTION OF THE DRAWINGS

Implementations of the present technology will now be described, by way of example only, with reference to the attached figures, wherein:

FIG. 1 is a flow chart of a method for determining video continuity according to one embodiment of the present disclosure.

FIG. 2 is block diagram of an apparatus configured for determining video continuity according to one embodiment of the present disclosure.

### DETAILED DESCRIPTION

It should be understood that the detailed description and specific examples, while indicating exemplary embodiments, are intended for purposes of illustration only and are not intended to limit the scope of the claims.

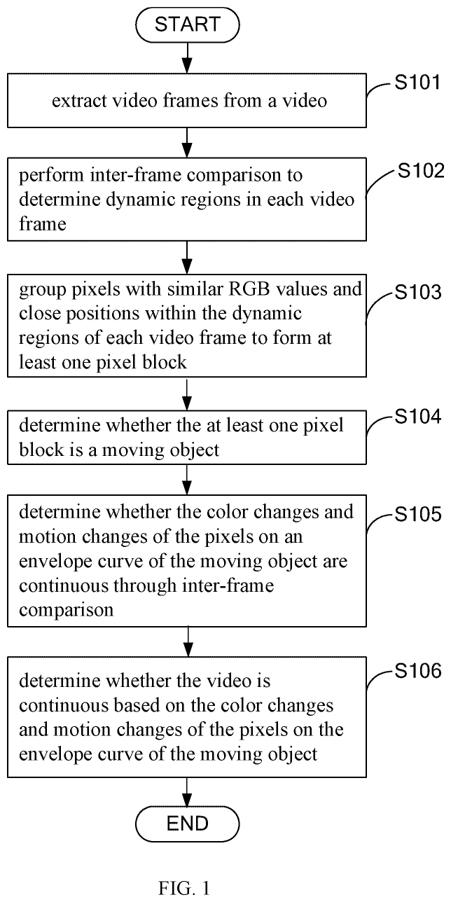

FIG. 1 is a flow chart of a method for determining video continuity.

Step S101, extracting video frames from the video.

In one embodiment, when the video continuity determination method is applied to a server, the server obtains a video to be processed from a terminal or another server, and extracts video frames from the video.

For example, the server can communicate with at least one vehicle. The vehicle's on-board terminal periodically uploads the saved video to the server, and the server executes the video continuity determination method to determine whether the video is continuous. If the video is determined to be continuous, it means that the video has not been edited. If the video is determined to be discontinuous, it means that the video has been edited before uploading.

Step S102, performing inter-frame comparison to determine dynamic regions in each video frame.

In one embodiment, a three-frame difference method can be used to determine the dynamic regions in each video frame.

In another embodiment, the original R, G, and B values of each pixel in each video frame can be recorded first. Then, the R, G, and B channels of each video frame are normalized. It should be noted that the method of normalizing color channels can refer to the existing technology, and the present invention will not be further elaborated here. For each pixel of each normalized video frame, the R, G, and B differences from the adjacent frame are calculated, and the R, G, and B differences are compared with a preset difference threshold. If any of the R, G, or B differences of any pixel in the video frame is greater than the preset difference threshold, it is determined that the corresponding position of the pixel is a dynamic region. If all the R, G, and B differences of the pixel are less than the preset difference threshold, it is determined that the corresponding position of the pixel is not a dynamic region. The preset difference threshold can be set according to experience or actual needs. For example, the preset difference threshold is set to 0.01. According to the results of inter-frame comparison of each video frame, the dynamic regions of each video frame can be obtained.

Step S103, grouping pixels with similar RGB values (e.g., homogenous values) and close positions within the dynamic regions of each video frame to form at least one pixel block.

For example, a pattern or group of pixels may have similar RGB values along one or more body area location(s), including, for example, a jawline, arm, other such body portion of a user having curves or contours. In one embodiment, an envelope curve is marked for the at least one pixel block to further determine whether the at least one pixel block is a moving object.

Step S104, determining whether the at least one pixel block is a moving object.

In one embodiment, through inter-frame comparison, it can be determined whether the at least one pixel block is a moving object based on whether the RGB values of the envelope curve of the at least one pixel block change and/or whether the RGB values of the pixels in the at least one pixel block change. If the RGB values of the envelope curve of the at least one pixel block change during inter-frame comparison or the original RGB values of the pixels in the at least one pixel block change during inter-frame comparison, it is determined that the at least one pixel block is a moving object.

In one embodiment, in order to eliminate the misjudgment of a moving object caused by changes in RGB values due to external factors such as brightness and noise, it is necessary to further determine whether the changes in RGB values of pixels with changed RGB values and their adjacent pixels are consistent.

Specifically, if the RGB values of the envelope curve of the at least one pixel block do not change during inter-frame comparison, but the RGB values of the pixels in the pixel block change during inter-frame comparison, it is necessary to further determine whether it is caused by external interference or a change in the color itself.

The determination method is as follows: If a pixel whose RGB value changes during inter-frame comparison also undergoes the same change in RGB value as its adjacent pixels, for example, both change from a first value to a second value, it is determined that there is a moving object at the position of the pixel and its adjacent pixels. However, if a pixel whose RGB value changes during inter-frame comparison does not undergo the same change in RGB value as its adjacent pixels, it is determined that the change in RGB value of the pixel and its adjacent pixels is caused by external interference or a change in the color itself.

Step S105, determining whether the color changes and motion changes of the pixels on the envelope curve of the moving object are continuous through inter-frame comparison.

In one embodiment, determining whether the color changes of the pixels on the envelope curve of the moving object are continuous specifically includes: determining whether the pixels on the envelope curve of the moving object whose colors changes change synchronously with inter-frame changes, and whether the color changes of the pixels on the envelope curve and the color changes of adjacent pixels have the same direction. When the pixels on the envelope curve of the moving object whose colors changes change synchronously with inter-frame changes, and the color changes of the pixels on the envelope curve and the color changes of adjacent pixels have the same direction, it is determined that the color changes of the pixels on the envelope curve of the moving object are continuous.

Herein, the same direction means that the directions of change of the two are the same according to the direction of change of the pixel color.

For example, if the RGB value C1 of pixel P1 on the envelope curve is located at position X1, and the RGB value C2 of its adjacent pixel P2 is located at position X2, and in the next frame, the RGB value of the pixel at position X2 is C1 and the RGB value of the pixel at position X3 is C2, it is determined that the color changes of the pixels on the envelope curve of the moving object and the color changes of adjacent pixels have the same direction.

In the part of determining whether the motion changes are continuous, for each pixel on the envelope curve, eight neighborhoods and their corresponding eight directions can be divided with the pixel as the center, and are represented by numbers 0 to 7 respectively.

The motion trajectory of the pixels on the envelope curve is represented by (X, Y), where X represents the deviation amplitude relative to the initial point and Y represents one of the eight directions. By comparing the (X, Y) of adjacent pixels on the envelope curve between frames, it can be determined whether the motion changes of the pixels on the envelope curve are continuous. Herein, the initial point can be defined by itself, such as setting the position of a pixel on the envelope curve or a pixel in a certain frame as the starting point.

Step S106, determining whether the video is continuous based on the color changes and motion changes of the pixels on the envelope curve of the moving object.

When the color changes and motion changes of the pixels on the envelope curve of the moving object are both continuous, it is determined that the video is continuous. Otherwise, when one of the color changes and motion changes of the pixels on the envelope curve of the moving object is not continuous, it is determined that the video is not continuous.

When it is determined that the video is continuous, it means that the video is real and is the original video. Otherwise, when it is determined that the video is not continuous, it means that the video has been edited or tampered with.

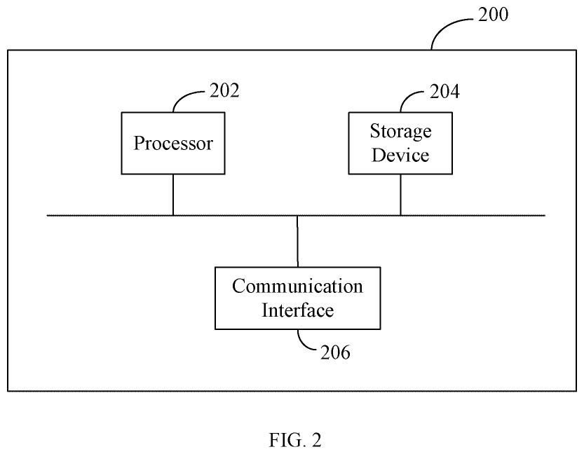

FIG. 2 is a block diagram of an apparatus 200 for determining video continuity. The apparatus 200 includes a processor 202, a storage device 204, and a communication interface 206. It should be understood by those skilled in the art that the composition of the apparatus 200 shown in FIG. 2 does not constitute a limitation of the embodiments of the present invention. The apparatus 200 shown in FIG. 2 is simplified for the purpose of description, and in different embodiments, it may include fewer or more components than those shown.

In one embodiment, the processor 202 may be composed of an integrated circuit, such as a single-packaged integrated circuit, or may be composed of multiple integrated circuits packaged with the same or different functions, including one or more central processing units (CPUs), microprocessors, digital signal processors, graphics processors, and various control chips. The processor 202 is the control core (Control Unit) of the apparatus 200, and connects various components of the apparatus 200 through various interfaces and lines. By running or executing computer programs or modules stored in the storage device 204 and calling data stored in the storage device 204, various functions of the apparatus 200 and data processing, such as the video continuity determination method, can be executed.

In one embodiment, the storage device 204 is used to store computer program codes and various data, such as early warning methods for dangerous driving behaviors, and to achieve high-speed and automatic access to programs or data during the operation of the apparatus 200. The storage device 204 may include a Read-Only Memory (ROM), a Programmable Read-Only Memory (PROM), an Erasable Programmable Read-Only Memory (EPROM), an One-time Programmable Read-Only Memory (OTPROM), an Ele 1ctrically-Erasable Programmable Read-Only Memory (EEPROM), a Compact Disc Read-Only Memory (CD-ROM) or other optical disk storage, a disk storage, a tape storage, or any other computer-readable storage medium capable of carrying or storing data.

In one embodiment, the communication interface 206 is composed of a communication circuit and is used to communicate data or information with external devices.

In summary, the method, apparatus, and non-transitory computer-readable storage medium for determining video continuity of the present invention can be used to detect video forgery by examining the consistency of motion patterns within the video sequences. The method, apparatus and the non-transitory computer-readable storage medium can effectively identify tampered videos and has broad applications in various fields, including digital forensics and content authentication.

It will be apparent to those skilled in the art that various modifications and variations can be made to the disclosure without departing from the scope or spirit of the claims. In view of the foregoing, it is intended that the present disclosure covers modifications and variations, provided they fall within the scope of the following claims and their equivalents.

What is claimed is:

1. A method to determine video continuity, the method comprising:
extracting video frames from a video;
performing inter-frame comparison to determine dynamic regions in each video frame;
grouping pixels with substantially equal RGB values and proximate positions within the dynamic regions of each video frame into at least one pixel block;
determining whether the at least one pixel block is a moving object; and
determining whether the video has continuity based on color changes of pixels and motion changes of pixels on an envelope curve of the moving object when the at least one pixel block is determined as the moving object.

2. The method of claim 1, wherein the determining the dynamic regions of each video frame comprises:
using a three-frame difference method to determine the dynamic regions of each video frame.

3. The method of claim 1, wherein the determining the dynamic regions of each video frame comprises:
recording original R, G, and B values of each pixel in each video frame;
normalizing R, G, and B channels of each video frame;
calculating the R, G, and B differences between each pixel of the normalized video frame and the corresponding pixel of an adjacent frame;
comparing each R, G, and B difference with a preset difference threshold;
determining that a position corresponding to a pixel is a dynamic region when one of the R, G, and B differences of the pixel in the video frame is greater than the preset difference threshold; and
determining that a position corresponding to a pixel is not a dynamic region when all R, G, and B differences of the pixel are less than the preset difference threshold.

4. The method of claim 1, wherein the determining whether the at least one pixel block is a moving object comprises:
determining whether RGB values of an envelope curve of the at least one pixel block change and whether original RGB values of each pixel within the at least one pixel block change to determine whether the at least one pixel block is the moving object; and
determining that the at least one pixel block is the moving object when the RGB values of the envelope curve of the at least one pixel block change in the inter-frame comparison or when the original RGB values of each pixel within the at least one pixel block change in the inter-frame comparison.

5. The method of claim 1, wherein the determining whether the video has continuity based on color changes and motion changes of pixels on the envelope curve of the moving object comprises:
determining, through inter-frame comparison, whether the color changes and motion changes of pixels on the envelope curve of the moving object are both continuous;
determining that the video has continuity when both the color changes and motion changes of pixels on the envelope curve of the moving object are continuous; and
determining that the video does not have continuity when one of the color changes or motion changes of pixels on the envelope curve of the moving object is not continuous.

6. The method of claim 5, further comprising:
determining whether the pixels of the envelope curve whose color changes change synchronously with inter-frame changes, and whether the color changes of the pixels on the envelope curve have a same direction as the color changes of adjacent pixels; and
determining that the color changes of pixels on the envelope curve of the moving object are continuous when the pixels of the envelope curve whose color changes change synchronously with inter-frame changes, and the color changes of the pixels on the envelope curve have the same direction as the color changes of adjacent pixels.

7. The method of claim 5, further comprising:
representing a motion trajectory of pixels on the envelope curve as (X, Y), wherein X represents a deviation amplitude relative to an initial point, and Y represents one of eight directions corresponding to eight neighborhoods divided with a pixel as a center, represented by numbers 0 to 7; and
comparing changes in (X, Y) between adjacent pixels on the envelope curve in inter-frames to determine whether the motion changes of pixels on the envelope curve are continuous.

8. An apparatus configured for determining video continuity, the apparatus comprising:
a non-transitory memory storage storing processor-executable instructions; and
at least one processor coupled to the memory to receive the processor-executable instructions, wherein, upon execution of the processor executable instructions, the at least one processor:
extracting video frames from a video;
performing inter-frame comparison to determine dynamic regions in each video frame;
grouping pixels with substantially equal RGB values and proximate positions within the dynamic regions of each video frame into at least one pixel block;
determining whether the at least one pixel block is a moving object; and
determining whether the video has continuity based on color changes of pixels and motion changes of pixels on an envelope curve of the moving object when the at least one pixel block is determined as the moving object.

9. The apparatus of claim 8, wherein the apparatus is a server.

10. A non-transitory computer readable storage medium storing processor-executable instructions which, when executed by at least one processor, cause the at least one processor to perform a method for determining video continuity, the method comprising:
extracting video frames from a video;
performing inter-frame comparison to determine dynamic regions in each video frame;
grouping pixels with substantially equal RGB values and proximate positions within the dynamic regions of each video frame into at least one pixel block;
determining whether the at least one pixel block is a moving object; and
determining whether the video has continuity based on color changes and motion changes of pixels on an envelope curve of the moving object when the at least one pixel block is determined as the moving object.
